(19) United States
(12) Patent Application Publication
(10) Pub. No.: US 2026/0304518 A1
(43) Pub. Date: Oct. 1, 2026

(54) CONTROL METHOD OF ELECTRONIC DEVICE UNDER COEXISTENCE OF EMLSR MODE AND OTHER WI-FI NETWORKS

(71) Applicant: MEDIATEK INC., Hsinchu City (TW)

(72) Inventors: Jen-Chieh Liu, Hsinchu City (TW); Cheng-Yi Chang, Hsinchu City (TW)

(73) Assignee: MEDIATEK INC., Hsinchu City (TW)

(21) Appl. No.: 19/090,420

(22) Filed: Mar. 26, 2025

(51) Int. Cl. H04W 76/15; H04W 52/02; H04W 76/30

(52) U.S. Cl. CPC H04W 76/15; H04W 52/0261; H04W 76/30

(57) ABSTRACT

The present invention provides a control method of an electronic device. The control method includes steps of: establishing a first link and a second link with a second electronic device, and using an EMLSR mode to communicate with the second electronic device; wirelessly connecting to a third electronic device, wherein a channel used for communication between the electronic device and the third electronic device is the same as a channel used in the first link; and after wirelessly connecting to the third electronic device, sending power management information to the second electronic device via the second link to notify that a wireless communication module corresponding to the second link is in a sleep mode.

### BACKGROUND

For next-generation Wi-Fi systems, Enhanced Multi-Link Single-Radio (EMLSR) operation has emerged as a promising feature to enhance overall system performance. EMLSR enables dynamic switching between multiple bands, offering a low-cost implementation with efficient power consumption. However, when a multi-link device (MLD) operates in EMLSR mode, it may encounter compatibility issues with other networks.

Specifically, an access point (AP) and a station can establish two links and operate in EMLSR mode, with the AP functioning as an AP MLD and the station as a non-AP MLD. In this mode, the station receives a trigger frame via both links but uses only one link (the one that receives the trigger frame from the AP) with all of its antennas to communicate with the AP. However, issues arise when the station also uses one of the links to communicate with another peer device. This can cause problems for either the peer device or the AP. For instance, if the AP and station are operating in EMLSR mode and have established two links, and the station establishes a new connection with the other peer device(s) where the new connection shares antenna and hardware circuits with one of the two links established between the AP and station, the other peer device may suffer some packet transmission issues. For example, during the communication between the station and AP with EMLSR mode, the other peer device will not be able to transmit any packet to the station, and will not know that it cannot transmit packet, which will cause retransmission and other problems.. This is because all the station's antennas and related hardware circuits are dedicated to the second link for AP communication.

Due to the aforementioned issues, when a new peer device is connected to the station, the MLO EMLSR mode used by the station and AP will need to be removed. In this case, the station uses the first link to communicate with the peer device and relies solely on the second link to communicate with the AP. However, this approach eliminates the benefits of EMLSR mode for communication with the AP.

Therefore, one of the objectives of the present invention is to provide a control method of the station, which can communicate with a peer device while operating in the EMLSR mode, to solve the above-mentioned problems.

According to one embodiment of the present invention, a control method of an electronic device is disclosed. The control method comprises steps of: establishing a first link and a second link with a second electronic device, and using an EMLSR mode to communicate with the second electronic device; wirelessly connecting to a third electronic device, wherein a channel used for communication between the electronic device and the third electronic device is the same as a channel used in the first link; and after wirelessly connecting to the third electronic device, sending power management information to the second electronic device via the second link to notify that a wireless communication module corresponding to the second link is in a sleep mode.

According to one embodiment of the present invention, an electronic device comprising a first wireless communication module and a second wireless communication module is disclosed. The first wireless communication module establishes a first link with a second electronic device, the second wireless communication module establishes a second link with the second electronic device, and the electronic device uses an Enhanced Multi-Link Single-Radio (EMLSR) mode to communicate with the second electronic device. The first wireless communication module wirelessly connects to a third electronic device, and a channel used for communication between the electronic device and the third electronic device is the same as a channel used in the first link. After the first wireless communication module wirelessly connects to the third electronic device, the second wireless communication module sends power management information to the second electronic device to notify that the second wireless communication module is in a sleep mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system according to one embodiment of the present invention.

FIG. 2 is a flowchart of a control method of the electronic device according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to …”. The terms “couple” and “couples” are intended to mean either an indirect or a direct electrical connection. Thus, if a first device couples to a second device, that connection may be through a direct electrical connection, or through an indirect electrical connection via other devices and connections.

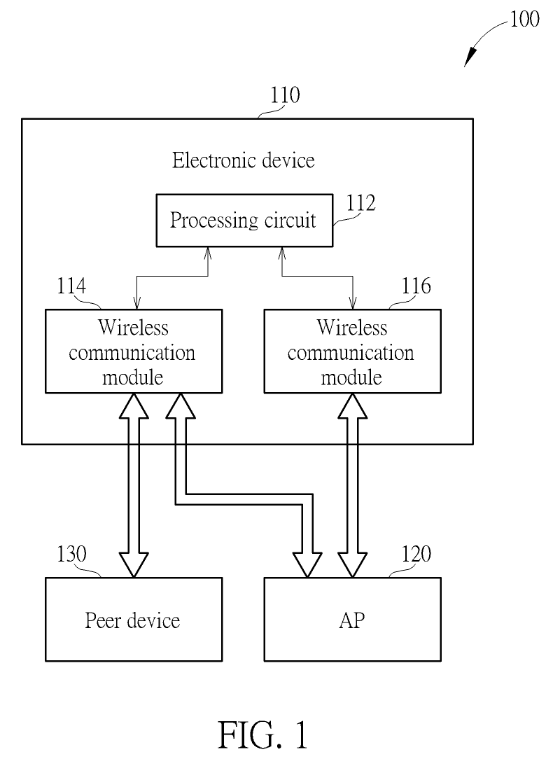

FIG. 1 is a diagram illustrating a wireless communication system 100 according to one embodiment of the present invention. As shown in FIG. 1, in the wireless communication system 100, the electronic device is communicated with an AP 120 and a peer device 130. In this embodiment, the electronic device 110 is a non-AP MLD, and the electronic device 110 mainly comprises a processing circuit 112 and a plurality of wireless communication modules such as 114 and 116. The AP 120 is a Wi-Fi AP MLD that allows other wireless devices such as the electronic device 110 to connect to a wired network. In this embodiment, the electronic device 110 can be a cell phone, a tablet, a notebook, or any other electronic device capable of wirelessly communicating with the AP 120. In addition, each of the wireless communication modules 114 and 116 comprises at least a media address control (MAC) layer circuitry and a physical layer circuitry, and the wireless communication modules 114 and 116 can be arranged in a single chip or different chips.

The electronic device 110 and the AP 120 can communicate with each other using two or more links, with both devices supporting the EMLSR mode. In this embodiment, the electronic device 110 establishes a first link with the AP 120 via the wireless communication module 114. This first link operates on a channel within one of the following frequency bands: the 2.4GHz band (e.g., 2.412GHz to 2.484GHz), the 5GHz band (e.g., 4.915GHz to 5.825GHz), or the 6GHz band (e.g., 5.925GHz to 7.125GHz). Additionally, the electronic device 110 establishes a second link with the AP 120 through the wireless communication module 116, with this second link operating on a channel within a different frequency band, selected from the 2.4GHz, 5GHz, or 6GHz bands.

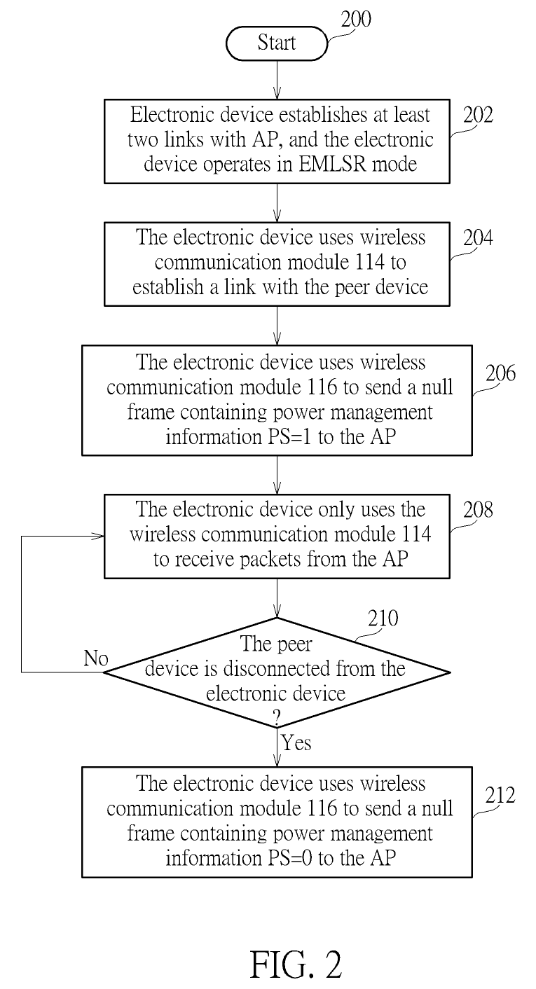

FIG. 2 is a flowchart of a control method of the electronic device 110 according to one embodiment of the present invention. In Step 200, the flow starts, and the electronic device 110 has been powered on. In Step 202, the electronic device 110 establishes at least two links with the AP 120, and the electronic device 110 operates in the EMLSR mode with the AP 120. Specifically, the electronic device 110 uses the wireless communication modules 114 and 116 to establish two links with the AP 120, respectively, wherein the wireless communication modules 114 and 116 may use channels corresponding two of the 2.4GHz band, 5GHz band and 6GHz band, respectively. In the operation of the EMLSR mode, when the electronic device 110 wants to transmit packet to the AP 120, the electronic device 110 can select one of the two links (one of the wireless communication modules 114 and 116), and switches all the antennas to the selected wireless communication module, and only uses the selected wireless communication module to transmit the packet to the AP 120. In addition, the electronic device 110 use two links to listen for trigger frame, which indicate whether the AP 120 is ready to transmit a packet. Specifically, each of the wireless communication modules 114 and 116 may use one antenna to listen for trigger frame, and if the wireless communication module 114 receives the trigger frame such as MU-RTS (multi-user request-to-send) defined in a Wi-Fi specification, both antennas are assigned to the wireless communication module 114, and the wireless communication module 114 sends a CTS (clear-to-send) signal to the AP 120 to make the AP 120 able to send the packet. Similarly, if the wireless communication module 116 receives the trigger frame, both antennas are assigned to the wireless communication module 116, and the wireless communication module 116 sends a CTS signal to the AP 120 to make the AP 120 able to send the packet.

In Step 204, the electronic device 110 begins using the wireless communication module 114 to establish a link with the peer device 130. In this embodiment, the wireless communication module 114 uses the same channel to communicate with the AP 120 and the peer device 130.

It is noted that the execution order of Step 202 and Step 204 is only used as an example, and is not a limitation of the present invention. In another embodiment, the electronic device 110 can establish a link with the peer device 130 first, then the electronic device 110 establishes two links with the AP 120 and operates in the EMLSR mode.

In Step 206, after the peer device 130 establishes the link with the electronic device 110, the electronic device 110 uses the wireless communication module 116 to send a null frame containing power management information to the AP 120, notifying it that the wireless communication module 116 is in sleep mode. In this embodiment, the power management information may include a power management bit that indicates whether the electronic device 110 is in an active mode or a sleep mode. For example, the wireless communication module 116 can send a null frame with a power management bit set to "0" (i.e., PS=0) to the AP 120, indicating that the wireless communication module 116 is in active mode. Conversely, the wireless communication module 116 can send a null frame with the power management bit set to "1" (i.e., PS=1) to the AP 120, indicating that the wireless communication module 116 is in sleep mode.

In Step 208, upon receiving the notification that the wireless communication module 116 is in sleep mode, the AP 120 will not use the link corresponding to the wireless communication module 116 to transmit trigger frames. That is, the electronic device 110 only uses the wireless communication module 114 to receive packets from the AP 120. This prevents the trigger frame retransmission issue described in the background of the present invention.

It is important to note that the electronic device 110 continues to operate in EMLSR mode in Step 208. Specifically, the AP 120 will always send trigger frames to the wireless communication module 114, and the electronic device 110 will switch all antennas to the wireless communication module 114 to receive packets from the AP 120.

In one embodiment of Step 208, the electronic device 110 can determine the communication type between the electronic device 110 and the AP 120 to determine if using the wireless communication module 116 to transmit the packet to the AP 120. Specifically, if the electronic device 110 and the AP 120 need to send packets to each other (e.g., the normal operation between AP and station), the electronic device 110 does not send any packet to the AP 120 via the wireless communication module 116 that has been deemed by the AP 120 to be operating in sleep mode. If the peer device 130 is replaced by another electronic device such as Wi-Fi display (WFD), the electronic device 110 may select one of the wireless communication modules 114 and 116 having better quality to transmit packet to the AP 120, because the WFD (peer device 130) hardly sends any packet to the electronic device 110. In this case, this mechanism will not be affected by the TRX problem under the coexistence between the peer device 130 or AP 120 and the electronic device 110.

In Step 210, the processing circuit 112 or the wireless communication module 114 determines if the peer device 130 is disconnected from the electronic device 110, if yes, the flow enters Step 212; and if not, the flow goes back to Step 208.

In Step 212, the electronic device 110 uses the wireless communication module 116 to send a null frame containing power management information to the AP 120, notifying it that the wireless communication module 116 is in active mode. As a result, the AP 120 can send trigger frames to either of the wireless communication module 114 or 116, whereas in Step 208, the AP 120 can only send trigger frames to the wireless communication module 114.

In the embodiment shown in FIG. 2, by sending power management information to the AP 120 to notify it that the wireless communication module 116 is in sleep mode when the peer device establishes a link with the wireless communication module 114 of the electronic device 110, the electronic device 110 can operate in EMLSR mode without causing transmission failures between the AP 120 and the peer device 130, as described in the background of the present invention. As a result, the wireless communication system 100 can achieve better performance and lower power consumption while supporting the coexistence of EMLSR mode and other Wi-Fi networks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of an electronic device, wherein the electronic device is a first electronic device, and the control method comprises steps of:
establishing a first link and a second link with a second electronic device, and using an Enhanced Multi-Link Single-Radio (EMLSR) mode to communicate with the second electronic device;
wirelessly connecting to a third electronic device, wherein a channel used for communication between the electronic device and the third electronic device is the same as a channel used in the first link; and
after wirelessly connecting to the third electronic device, sending power management information to the second electronic device via the second link to notify that a wireless communication module corresponding to the second link is in a sleep mode.

2. The control method of claim 1, further comprising:
disconnecting from the third electronic device; and
after disconnecting from the third electronic device, sending the power management information to the second electronic device to notify that the wireless communication module corresponding to the second link is in an active mode.

3. The control method of claim 1, further comprising:
after sending the power management information to the second electronic device to notify that the wireless communication module corresponding to the second link is in the sleep mode, using the EMLSR mode and only using the first link to communicate with the second electronic device.

4. The control method of claim 1, further comprising:
after sending the power management information to the second electronic device to notify that the wireless communication module corresponding to the second link is in the sleep mode, determining a communication type between the electronic device and the third electronic device to determine whether to use the second link to communicate with the second electronic device.

5. The control method of claim 4, wherein the step of determining the communication type between the electronic device and the third electronic device to determine whether to use the second link to communicate with the second electronic device comprises:
if the third electronic device is a Wi-Fi display, selecting one of the first link and the second link to communicate with the second electronic device.

6. The control method of claim 1, wherein the first link uses a channel corresponding to a 5 GHz frequency band or a 6 GHz frequency band, and the second link uses a channel corresponding to another one of the 5 GHz frequency band and the frequency 6 GHz band.

7. An electronic device, comprising:
a first wireless communication module; and
a second wireless communication module;
wherein the first wireless communication module establishes a first link with a second electronic device, the second wireless communication module establishes a second link with the second electronic device, and the electronic device uses an Enhanced Multi-Link Single-Radio (EMLSR) mode to communicate with the second electronic device;
wherein the first wireless communication module wirelessly connects to a third electronic device, and a channel used for communication between the electronic device and the third electronic device is the same as a channel used in the first link; and after the first wireless communication module wirelessly connects to the third electronic device, the second wireless communication module sends power management information to the second electronic device to notify that the second wireless communication module is in a sleep mode.

8. The electronic device of claim 7, wherein the first wireless communication module disconnects from the third electronic device; and after disconnecting from the third electronic device, the second wireless communication module sends the power management information to the second electronic device to notify that the second wireless communication module is in an active mode.

9. The electronic device of claim 7, wherein after the second wireless communication module sends the power management information to the second electronic device to notify that the second wireless communication module is in the sleep mode, the electronic device uses the EMLSR mode and only using the first link to communicate with the second electronic device.

10. The electronic device of claim 7, wherein after the second wireless communication module sends the power management information to the second electronic device to notify that the second wireless communication module is in the sleep mode, the electronic device determines a communication type between the electronic device and the third electronic device to determine whether to use the second link to communicate with the second electronic device.

11. The electronic device of claim 10, wherein if the third electronic device is a Wi-Fi display, the electronic device selects one of the first link and the second link to communicate with the second electronic device.

12. The electronic device of claim 7, wherein the first link uses a channel corresponding to a 5 GHz frequency band or a 6 GHz frequency band, and the second link uses a channel corresponding to another one of the 5 GHz frequency band and the 6 GHz frequency band.
